(19) United States
(12) Patent Application Publication
(10) Pub. No.: US 2008/0012967 A1
(43) Pub. Date: Jan. 17, 2008

(54) DEFECTIVE-AREA CORRECTION APPARATUS, METHOD AND PROGRAM AND RADIATION DETECTION APPARATUS

(75) Inventor: Takao Kuwabara, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/777,670

(22) Filed: Jul. 13, 2007

(30) Foreign Application Priority Data
Jul. 13, 2006 (JP) 2006-192548

(51) Int. Cl. H04N 9/64

(52) U.S. Cl. 348/246

(57) ABSTRACT

Correction is performed on the pixel values of a plurality of defective pixels forming a defective area of an image representing a subject image. The defective area is an area corresponding to a defective portion of a detector. A plurality of weighted normal pixel values are obtained by weighting the pixel value of each of normal pixels adjacent to the periphery of the defective area for each pair of a correction-target defective pixel and each of the normal pixels using a weighting coefficient. The weighting coefficient becomes smaller as a distance between the defective pixel and the normal pixel becomes longer. Then, an average value of the plurality of weighted normal pixel values is calculated, and the pixel value of the correction-target defective pixel is corrected using the calculated average value. This process is performed on each of the defective pixels.

### BACKGROUND OF THE INVENTION

1. Field of the Invention

The present invention relates to a defective-area correction apparatus and method and a program for the defective-area correction apparatus and method. Further, the present invention relates to a radiation detection apparatus. Specifically, the present invention relates to a defective-area correction apparatus, method and program for correcting the pixel values of a plurality of defective pixels forming a defective area of an image representing a subject image (the image of a subject), the defective area corresponding to a defective portion of a detector. The defective-area correction apparatus, method and program correct the pixel values by detecting one of light and radiation including information about the subject image using the detector to obtain the image representing the subject image and by identifying the defective area of the image representing the subject image. The present invention also relates to the radiation detection apparatus using the method.

2. Description of the Related Art

Conventionally, a radiographic image recording/regeneration system including a radiographic image recording apparatus, a radiographic image readout apparatus and the like is known as a CR (Computed Radiography) system. In the radiographic image recording/regeneration system, a storage phosphor (stimulable phosphor) is utilized. The storage phosphor stores a part of radiation energy received by irradiation with radiation, such as X-rays. After the radiation energy is stored, if the storage phosphor is irradiated with stimulating light, such as visible light, the storage phosphor emits stimulated-emission light (photostimulated light) corresponding to the stored radiation energy. In the radiographic image recording/regeneration system, a radiographic image of a subject, such as a human body, is recorded in a storage phosphor layer once as a latent image. Then, the storage phosphor layer is irradiated with stimulating light, such as laser light, to cause the storage phosphor layer to emit stimulated light. Further, the emitted stimulated light is photo-electrically detected and image data representing the radiographic image of the subject is obtained.

As a recording medium used in the radiographic image recording/generation system, a radiographic image conversion panel, which is produced by depositing a storage phosphor layer on a substrate (support or base plate), is known. The radiographic image conversion panel is exposed to radiation transmitted through a subject and a radiographic image of the subject is recorded on the radiographic image conversion panel. Then, image data representing the radiographic image of the subject recorded on the radiographic image conversion panel is obtained by detecting stimulated light emitted from the radiographic image conversion panel by irradiation with stimulating light. After the image data representing the radiographic image of the subject is read out from the radiographic image conversion panel, as described above, radiographic energy remaining on the radiographic image conversion panel is discharged from the radiographic image conversion panel by irradiating the radiographic image conversion panel with deletion light. Consequently, it becomes possible to record a new radiographic image on the radiographic image conversion panel. Hence, the radiographic image conversion panel can be repeatedly used to record and regenerate radiographic images representing the subject.

Further, in some cases, a defective portion of the radiographic image conversion panel formed by a partial damage to the radiographic image conversion panel or the like is displays as a defective portion of an image represented by the obtained image data. A method for correcting image data corresponding to the position of the defective portion using image data representing the periphery of the defective portion is known (for example, please refer to Japanese Unexamined Patent Publication No. 2000-284059, Japanese Unexamined Patent Publication No. 2004-233448 and Japanese Unexamined Patent Publication No. 2005-284873). In this correction method, the position of the defective portion of the radiographic image conversion panel is recorded in advance, and when new image data is obtained, image data corresponding to the recorded position of the defective portion is corrected using image data representing the periphery of the defective portion. In this correction method, the pixel value of a correction target pixel is replaced, for example, with an average value of the pixel values of pixels adjacent to the correction target pixel. The pixels adjacent to the correction target pixel are four pixels located on four sides (up, down, left and right) of the correction target pixel, or four pixels diagonally located with respect to the correction target pixel. Alternatively, the pixels adjacent to the correction target pixel are eight pixels including the four pixels on the four sides of the correction target pixel and the four pixels diagonally located with respect to the correction target pixel.

However, in this correction method, when the defective portion includes a multiplicity of defective pixels, many defective pixels are present around defective pixels located in the vicinity of the center of the defective portion. Or, only defective pixels are present around the defective pixels located in the vicinity of the center of the defective portion. In such a case, correction must be first performed on defective pixels adjacent to relatively many normal pixels. The defective pixels adjacent to relatively many normal pixels are defective pixels located close to the outer side of the defective portion. Correction is performed on the defective pixels located close to the outer side of the defective portion using the pixel values of normal pixels in the vicinity of the defective pixels. Then, correction target pixels are gradually changed toward the center of the defective portion, and correction is further performed using the corrected pixel value or values.

However, if correction is performed in such a manner, the pixel values of pixels in the vicinity of the center of the defective portion are obtained by performing correction based on values obtained by performing correction many times. Therefore, the image of the corrected defective portion tends to look unnatural.

### SUMMARY OF THE INVENTION

In view of the foregoing circumstances, it is an object of the present invention to provide a defective-area correction apparatus, method and program for correcting a defective area formed by a plurality of defective pixels in an image so that a corrected area looks natural.

A defective-area correction apparatus of the present invention is a defective-area correction apparatus for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the apparatus comprising:

a normal-pixel-value weighting means for obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;

an average-value calculation means for calculating an average value of the obtained plurality of weighted normal pixel values; and

a pixel value correction means for correcting the pixel value of the correction target defective pixel using the calculated average value.

With respect to the process of identifying the defective area, the position of the defective area of the image may be obtained in advance based on a so-called “Beta” image in Japanese (a uniformly-exposed image). The uniformly exposed image is obtained by detecting uniform light or radiation by a detector in a state without placing a subject. Then, an area of an image of a subject (hereinafter, also referred to as a subject image) located at the relevant position may be identified as a defective area. Alternatively, the defective area may be identified by searching the subject image for the defective area, based on the uniformly exposed image, by using template matching technique or the like.

Further, “each of normal pixels adjacent to the periphery of the defective area” may be each of all normal pixels adjacent to the periphery or boundary of the defective area. Alternatively, “each of normal pixels adjacent to the periphery of the defective area” may be each of normal pixels obtained by performing thinning on the all normal pixels adjacent to the periphery of the defective area. Further, the normal pixels adjacent to the periphery of the defective area may include only pixels immediately adjacent to the defective area, in other words, pixels contacting with the defective area. Alternatively, the normal pixels adjacent to the periphery of the defective area may further include outer pixels contacting with the pixels immediately adjacent to the defective area in addition to the pixels immediately adjacent to the defective area.

Further, “an average value of weighted normal pixel values” may be calculated by obtaining weighted normal pixel values and the average of the weighted normal pixel values at one time instead of separately calculating the weighted normal pixel values and the average value.

Further, the expression “correcting the pixel value using the average value” may refer to replacing the pixel value with the average value. Alternatively, the expression may refer to replacing the pixel value with a value obtained by appropriately processing the average value.

In the defective-area correction apparatus of the present invention, the normal-pixel-value weighting means may obtain the weighted normal pixel values by multiplying the pixel value of each of the normal pixels by a weighting coefficient, the weighting coefficient becoming exponentially smaller depending on the distance (length).

A defective-area correction method of the present invention is a defective-area correction method for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the method comprising:

obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;

calculating an average value of the obtained plurality of weighted normal pixel values; and

correcting the pixel value of the correction target defective pixel using the calculated average value.

A program of the present invention is a program for causing a computer to function as a defective-area correction apparatus for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the program comprising the procedures for causing the computer to function as:

a normal-pixel-value weighting means for obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;

an average-value calculation means for calculating an average value of the obtained plurality of weighted normal pixel values; and

a pixel value correction means for correcting the pixel value of the correction target defective pixel using the calculated average value.

A radiation detection apparatus of the present invention is a radiation detection apparatus comprising:

a radiation detection means for storing a latent image of a subject;

an image generation means for generating image data by reading the latent image from the radiation detection means;

a defective-area identification means for identifying a defective area of an image represented by the generated image data, the defective area including a set of at least two defective pixels;

a defective-pixel identification means for identifying a first defective pixel within the defective area;

a normal-pixel identification means for identifying a first normal pixel adjacent to the periphery of the defective area;

a distance measurement means for measuring a first distance between the first defective pixel and the first normal pixel;

a weighting-coefficient calculation means for calculating a weighting coefficient, the weighting coefficient becoming smaller as the distance measured by the distance measurement means becomes longer;

a normal-pixel-data-value weighting means for obtaining a first weighted normal pixel data value by multiplying the data value of the first normal pixel by a weighting coefficient corresponding to the distance; and

a defective-pixel data value correction means for replacing the data value of the first defective pixel with an average value of a plurality of weighted normal pixel data values including the first weighted normal pixel data value and a second weighted normal pixel data value, the second weighted normal pixel data value being obtained with respect to a second normal pixel, the second normal pixel being different from the first normal value identified by the normal-pixel identification means, by calculating the average value.

According to a defective-area correction apparatus and method of the present invention, an image representing a subject image is obtained by detection of one of light and radiation including information about the subject image using a detector, and a defective area of the image representing the subject image is identified. The defective area of the image is an area corresponding to a defective portion of the detector. Then, the pixel values of a plurality of defective pixels forming the defective area of the image representing the subject image are corrected. In the defective-area correction apparatus and method of the present invention, a plurality of weighted normal pixels values are obtained by weighting the pixel value of each of normal pixels adjacent to the periphery of the defective area for each pair of a correction target defective pixel and each of the normal pixels using a weighting coefficient. The weighting coefficient becomes smaller as a distance between the correction target defective pixel and the normal pixel becomes longer. Further, an average value of the plurality of weighted normal pixel values is calculated and the pixel value of the correction target defective pixel is corrected using the calculated average value. Therefore, when the plurality of defective pixels forming the defective area are corrected, defective pixels near the normal pixels on the outside of the defective area are highly affected by the values of the normal pixels near the defective pixels. In contrast, the pixel values of defective pixels located near the center of the defective area are corrected to pixel values close to an average value of the normal pixels on the periphery of the defective area. Accordingly, correction can be performed so that the corrected image has natural density gradation.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a radiographic system and a defective-area correction apparatus according to an embodiment of the present invention;

FIG. 2 is a diagram illustrating the configuration of a correction processing unit in the defective-area correction apparatus;

FIG. 3A is a diagram illustrating shift-induced residuals after correcting the defective area;

FIG. 3B is a diagram illustrating shift-induced residuals after correcting the defective area;

FIG. 4 is a diagram illustrating a manner in which a defect reference image is generated from a uniformly-exposed image;

FIG. 5 is a diagram illustrating a manner in which a defect extraction image is generated from a subject image;

FIG. 6 is a diagram illustrating a state in which the defect reference image and the defect extraction image are superimposed one on the other in such a manner that the coordinate axes of the defect reference image coincide with those of the defect extraction image;

FIG. 7 is a diagram illustrating an example of a defective image A;

FIG. 8A is a diagram illustrating the density profile of the defective image A;

FIG. 8B is a diagram illustrating the density profile of a corresponding-area image A′;

FIG. 9 is a graph obtained by accumulating peak heights for each shift amount of peaks between the density profile of the defective image A and that of the corresponding-area image A′;

FIG. 10 is a diagram illustrating positional relationships between a true defective area B and tentatively-determined defective areas B′ and density profiles after correcting the tentatively-determined defective areas B′;

FIG. 11 is a diagram illustrating the distribution of density gradients in the defective image A;

FIG. 12 is a diagram illustrating the defective area B and normal pixels on the periphery of the defective area B; and

FIG. 13 is a diagram illustrating a weighting coefficient curve, which is used for weighting the pixel values of normal pixels.

### DESCRIPTION OF THE PREFERRED EMBODIMENTS

Hereinafter, embodiments of the present invention will be described with reference drawings.

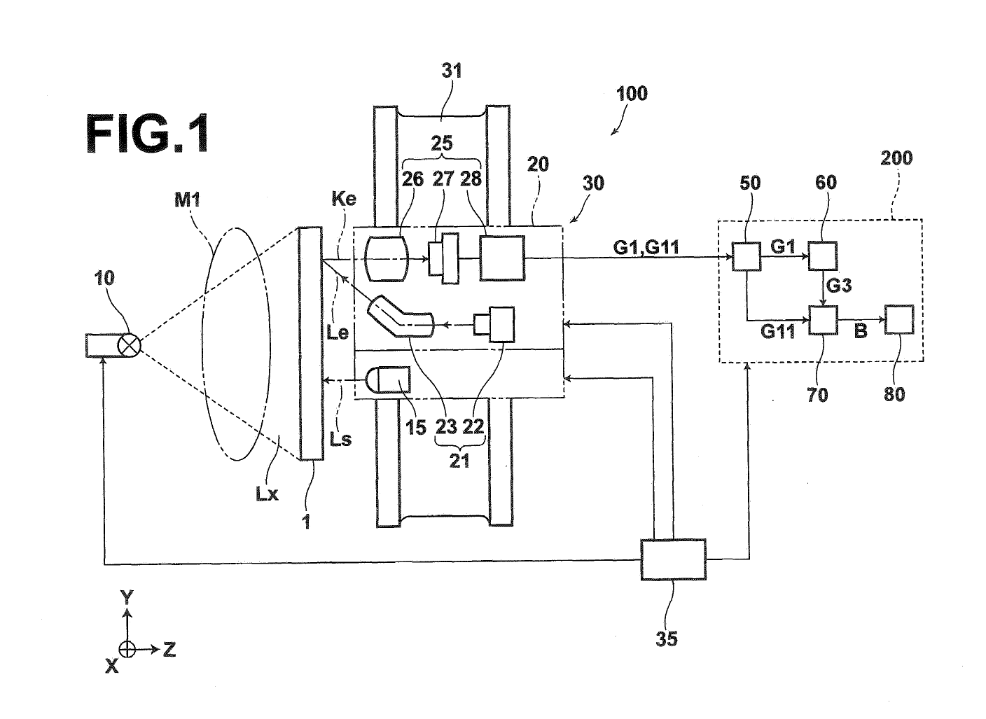

FIG. 1 is a schematic diagram illustrating the configuration of a radiographic system and a defective-area correction apparatus according to an embodiment of the present invention. The radiographic system obtains a radiographic image representing a subject by exposing the subject to radiation and by detecting radiation including information about the image of the subject using a detector. Further, the defective-area correction apparatus obtains the radiographic image obtained by the radiographic system and identifies a defective area of the radiographic image, the defective area corresponding to a defective portion of the detector. Further, the defective-area correction apparatus corrects the pixel values of a plurality of defective pixels forming the defective area.

A radiographic system 100 is illustrated in FIG. 1. The radiographic system 100 repeatedly performs photography (radiography), readout and deletion in this order on a storage phosphor sheet (storable phosphor sheet). The photography, the readout and the deletion are performed a plurality of times on the same storage phosphor sheet. The radiographic system 100 includes a photography unit 10, a readout unit 20, a deletion unit 15, an up/down drive unit 31 and a controller 35. The photography unit 10 obtains a radiographic image of a subject M1 by photography and records the obtained radiographic image on a storage phosphor sheet 1. The readout unit 20 obtains image data representing the radiographic image of the subject M1 by reading out data from the storage phosphor sheet 1. After the readout unit 20 reads out the data from the storage phosphor sheet 1, the deletion unit 15 deletes the data stored on the storage phosphor sheet 1 by irradiating the storage phosphor sheet 1 with deletion light Ls. The up/down drive unit 31 relatively moves the storage phosphor sheet 1 up and down when the readout unit 20 performs readout and when the deletion unit 15 performs deletion. The controller 35 controls information and the operation of the whole system.

The photography unit 10 includes a control unit and a radiation source. The control unit controls the radiation dose of radiation Lx. The radiation source emits radiation Lx under control by the control unit.

The readout unit 20 includes a stimulating-light irradiation unit 21 and a readout light-receiving unit 25. The stimulating-light irradiation unit 21 irradiates the storage phosphor sheet 1 with stimulating light (excitation light) Le. The readout light-receiving unit 25 outputs image data representing a radiographic image of the subject by detecting stimulated-emission light (stimulated light) Ke, emitted from the storage phosphor sheet 1 by irradiation with the stimulating light Le.

The stimulating-light irradiation unit 21 includes a laser light source 22 and an optical system 23. The optical system 23 condenses linear stimulating light Le emitted from the laser light source 22 into a linear area on the storage phosphor sheet 1, the linear area extending in a main scan direction (X-direction in FIG. 1).

The readout light-receiving unit 25 includes an optical system 26, a light-receiving unit 27 and an A/D (analog to digital) converter 28. The optical system 26 condenses stimulated-emission light Ke, emitted from the linear area of the storage phosphor sheet 1 by irradiation with the stimulating light Le, into a linear area on the light-receiving unit 27, which will be described later. The light-receiving unit 27 is a line sensor extending in the main scan direction. The light-receiving unit 27 receives the stimulated-emission light Ke condensed by the optical system 26 and performs photoelectric conversion on the received light. The A/D converter 28 converts analog image signals obtained by performing photoelectric conversion at the light-receiving unit 27 into image data represented by digital signals and outputs the image data.

The readout unit 20 and the deletion unit 15 are moved along the surface of the storage phosphor sheet 1 by the up/down drive unit 31. The readout unit 20 and the deletion unit 15 are moved forward and backward (up/down in FIG. 1) in a sub-scan direction (Y-direction in FIG. 1), which is orthogonal to the main scan direction. Accordingly, readout and deletion are performed on the storage phosphor sheet 1.

Meanwhile, a defective-area correction apparatus 200 illustrated in FIG. 1 includes an image obtainment unit 50, a defect-reference-image obtainment unit 60, a defective-area identification unit 70 and a correction processing unit 80. The image obtainment unit 50 obtains a uniformly-exposed image G1 and a subject image G11. The uniformly-exposed image G1 is an image obtained by the radiographic system by detecting radiation that has not been transmitted through a subject. The subject image G11 is an image obtained by the radiographic system by detecting radiation that has been transmitted through a subject. The defect-reference-image obtainment unit 60 obtains a defect reference image G3 based on the uniformly-exposed image G1. The defect reference image G3 shows defective images A1, A2, . . . (hereinafter, a defective image and all defective images are referred to as a defective image A and defective images A). The defective images A1, A2, . . . correspond to defective portions of the storage phosphor sheet (detector) 1, such as an insufficient light emission portion. The defective-area identification unit 70 identifies defective areas B1, B2, . . . (hereinafter, a defective area and all defective areas are referred to as a defective area B and defective areas B) by referring to the defect reference image G3. The defective areas B1, B2, . . . are areas of the subject image corresponding to the defective portions of the storage phosphor sheet 1. The correction processing unit 80 performs correction on the identified defective areas B1, B2, . . . of the subject image G11.

The image obtainment unit 50 obtains a uniformly-exposed image obtained by the radiographic system 100. The uniformly-exposed image is an image representing radiation energy stored in the storage phosphor sheet 1 that has been uniformly exposed to radiation. The uniformly-exposed image is obtained by uniformly exposing the storage phosphor sheet (uniformly-exposed photography), from which data has been deleted, to radiation that has not been transmitted through the subject M1 and by reading out data from the storage phosphor sheet 1. The uniformly exposed image G1 includes a defective image corresponding to a defective portion of the storage phosphor sheet 1. Further, for the purpose of improving an SN (signal to noise) ratio, it is desirable that the uniformly exposed image G1 is generated by averaging a plurality of images obtained by performing uniformly-exposed photography at high doses more than once.

Further, the image obtainment unit 50 obtains the subject image G11 obtained by the radiographic system 100. Specifically, the image obtainment unit 50 obtains the subject image G11 representing radiation energy stored in the storage phosphor sheet 1 that has been irradiated with radiation that has been transmitted through the subject M1. The subject image G11 is obtained by reading the storage phosphor sheet 1 that has been exposed to radiation transmitted through the subject M1. The storage phosphor sheet 1 is exposed to the radiation after deletion of data therefrom. The subject image G11 includes a defective area B corresponding to a defective portion of the storage phosphor sheet 1. The defective area B is an area affected by insufficient light emission at the defective portion of the storage phosphor sheet 1.

The defect-reference-image obtainment unit 60 extracts an area of the uniformly-exposed image G1 as a defective image A. The area extracted as the defective image A is an area that includes pixels of which the pixel values (density values) are less than or equal to a predetermined threshold value, and in which at least a predetermined number of such pixels are substantially consecutively present in X-direction and/or Y-direction. Alternatively, the area extracted as the defective image A is an area, in which at least a predetermined number of such pixels in total are substantially consecutively present. In this case, such pixels may be located substantially next to each other in any direction. Further, the defect-reference-image obtainment unit 60 generates a defect reference image G3, which includes only the defective image or images A extracted from the uniformly exposed image G1. The judgment condition (classification condition) is determined by the “predetermined threshold value” and the “predetermined number”. A plurality of judgment conditions are prepared in advance in such a manner that the value of the “predetermined number” becomes smaller as the value of the “threshold value” becomes lower. A target area that satisfies one of the judgment conditions is judged as the defective image A.

However, depending on the methods for identifying a defective area B in the subject image G11, there are cases in which the size of the defective image A in the defect reference image G3 should be large and cases in which the size should be small. For example, in a method for identifying the position of the defective area B based on the amount of difference in the density, which will be described later, the size of the defective image A should be large. In contrast, in a method for identifying the position of the defective area B based on the degree of coincidence in the direction of the density gradient of the defective image A, the size of the defective image A should be small. Therefore, it is desirable that the size of the defective image A to be extracted is adjusted by changing the threshold value for judging the defect according to the adopted method for identifying the defective area B.

Further, the size of a defect to be extracted before introducing the defective-area correction apparatus into the market (during manufacture) may be different from the size of a defect to be extracted after introducing the defective-area correction apparatus into the market. Therefore, after the defective-area correction apparatus is introduced to the market, the threshold value for judging the defective images A1, A2, . . . is adjusted so that the sizes of the defective images A1, A2, . . . to be extracted become the maximum size of images that can be corrected.

Further, the defect-reference-image obtainment unit 60 eliminates pseudo-defects (false defects). If a defect is a pseudo-defect caused by adhesion of dust to a panel on the storage phosphor sheet 1, the pixel values of pixels in the defect are much lower (the brightness is higher) than those of pixels in a true defect caused by insufficient light emission of the storage phosphor sheet 1. Therefore, a predetermined pixel value that can be used to distinguish the pseudo-defect from the true defect is set as a standard value of pixel values. Then, pixels of which the pixel values are less than or equal to the standard value are judged as a pseudo-defect, and the pseudo-defect is eliminated from the defects to be extracted.

Further, the defect-reference-image obtainment unit 60 eliminates defects that do not require correction. There are cases in which defective pixels forming the defective image A are not easily recognizable because they are not distinguishable from surrounding noise depending on the pixel values (densities) of the defective pixels. Therefore, if the pixel values of the defective pixels are greater than or equal to a predetermined threshold value, the defective pixels are judged as a defect that is not easily recognizable, and which does not require correction. Then, the defect is eliminated from the defects to be extracted. Accordingly, it is possible to omit unnecessary correction processing.

Further, the defect-reference-image obtainment unit 60 may determine the type of correction applied to each defect. In other words, the defect-reference-image obtainment unit 60 may determine sensitivity correction/estimation correction for each defect. For example, the defect-reference-image obtainment unit 60 normally gives priority to sensitivity correction. However, in a certain condition, the defect-reference-image obtainment unit 60 gives priority to estimation correction because of the following reasons.

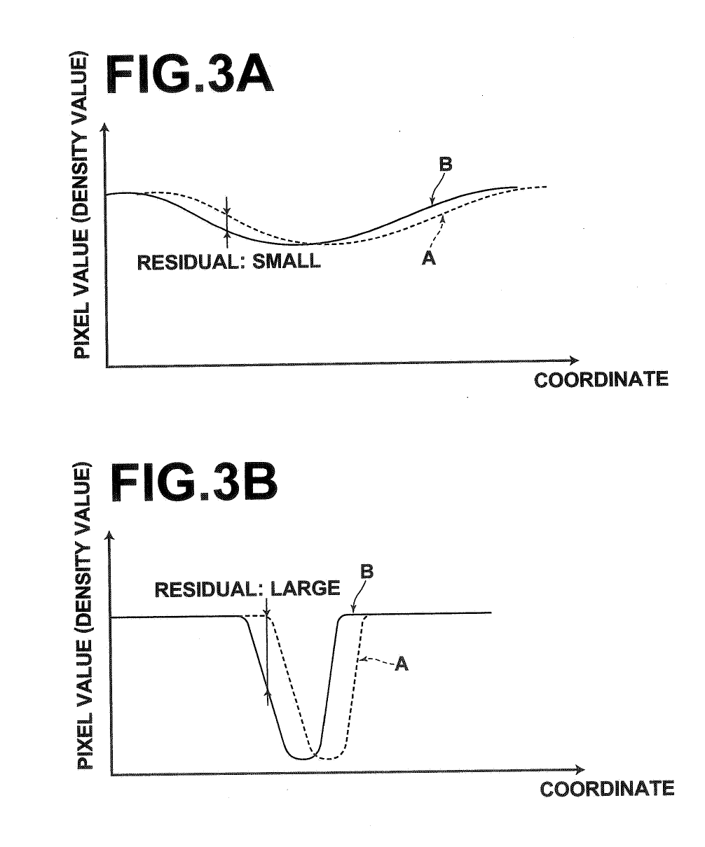

When data is read out from the storage phosphor sheet 1, if the position of a system is shifted, the position of a defective image A in a defect reference image G3 and that of a defective area B of a subject image Sb are shifted from each other by a certain range of distance, for example, by 0.5 pixel or less. As illustrated in FIGS. 3A and 3B, if a change in the density of the defective image A is sharp, easily-recognizable residuals, caused by the shift in position, remain even if sensitivity correction is performed on the defect. Therefore, in the defective image A, a difference in pixel values between a defective pixel and each of eight pixels surrounding the defective pixel is obtained. If the absolute value of at least one of the differences is greater than or equal to a predetermined threshold value, estimation correction is adopted. In the estimation correction, the pixel value of the defective pixel is estimated based on the pixels surrounding the defective pixel. It may be determined that the estimation correction is applied only to a target defective pixel or pixels satisfying this condition. Alternatively, it may be determined that the estimation correction is applied to all pixels in the defective image including the target defective pixel or pixels. In the present embodiment, estimation correction, which will be described later, is performed on the whole defective area.

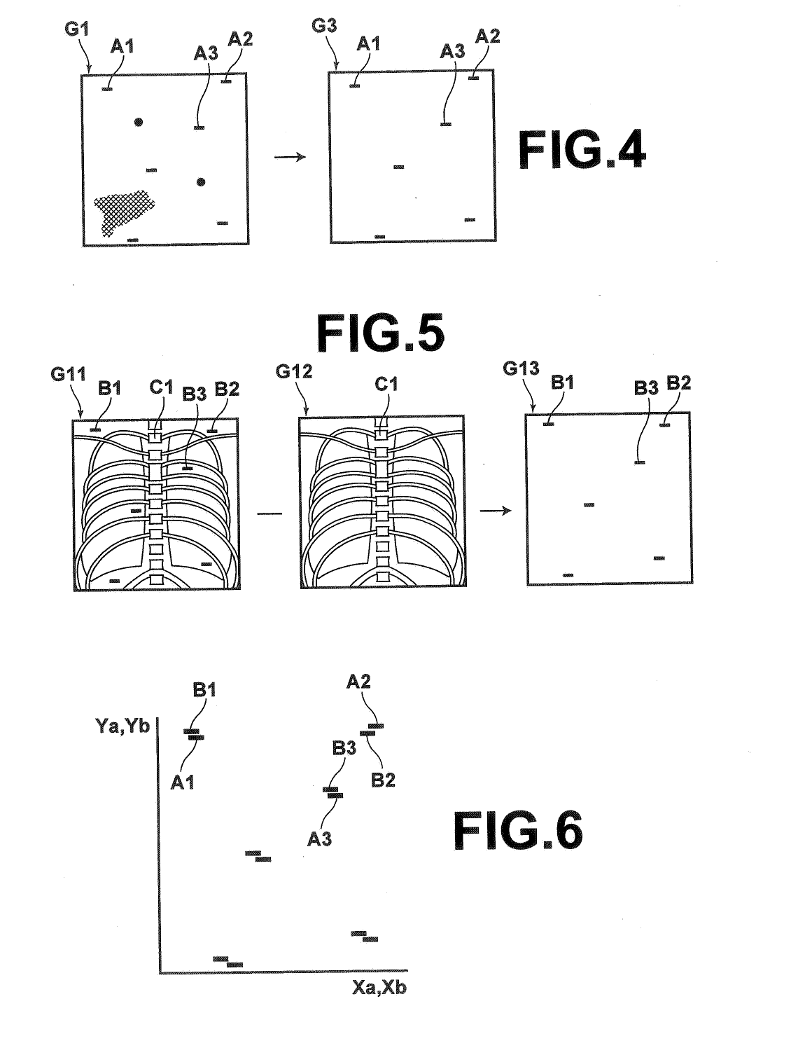

FIG. 4 is a diagram illustrating a manner in which a defect reference image G3 is generated from a uniformly exposed image G1. The defect reference image G3 is generated by eliminating pseudo-defects and defects that do not require correction, as described above.

The defective-area identification unit 70 identifies a defective area B of a subject image Sb with reference to the defect reference image G3. As the method for identifying the defective area B, there are a plurality of methods, as described below.

### 1) Identification Method by Pattern Matching

This identification method is a method for identifying a defective area B of a subject image G11 by performing pattern matching between the defective image A in the defect reference image G3 and the defective area B of the subject image G11. In this method, a median filter or moving average processing is utilized to extract the defective area B, as described later. Therefore, the accuracy of identification is high but processing time is long. This method is appropriate for identifying a relatively small defect.

First, median filter or moving average processing is performed on a subject image G11 including a radiographic image C1 and a defective area B. Consequently, the defective area B, which is a high-frequency component, is removed and a defect-removed image G12 is obtained. Then, a defect extraction image G13 is generated by subtracting the defect-removed image G12 from the subject image G11 to extract only the defective area B.

FIG. 5 is a diagram illustrating a manner in which the defect extraction image G13 is generated, as described above. The defect extraction image G13 is generated by subtracting the defect-removed image G12 from the subject image G11 including the radiographic image C1 and defective areas B1, B2,

Next, the defect reference image G3 and the defect extraction image G13 are superimposed one on the other in such a manner that the coordinate axes of the defect reference image G3 coincide with those of the defect extraction image G13. While the defect reference image G3 is moved within a predetermined range with respect to the defect extraction image G13, correlation values between the defective image A in the defect reference image G3 and the image of a corresponding area of the defect extraction image G13, the coordinates of the corresponding area being the same as those of the defective image A, are obtained. For each of the defective images A1, A2, . . . , a case in which the correlation value becomes the highest is obtained.

FIG. 6 is a diagram illustrating an example of a positional relationship between the defective images A1, A2, . . . and the defective areas B1, B2, . . . when the defect reference image G3 showing the defective images A1, A2, . . . and the defect extraction image G13 showing the defective areas B1, B2, . . . are superposed one on the other in such a manner that the coordinate axes (Xa, Ya) of the defect reference image G3 coincide with the coordinate axes (Xb, Yb) of the defect extraction image G13.

When the defect-removed image G12 is obtained, if the sampling number of the median filter is changed based on the size of the defective image A, it is possible to increase the processing speed.

Further, in pattern matching, a correlation value T may be calculated using the following equation (1):

$$T = {\sum }_{i = 1}^{n} \vert ( {E}_{i} - {F}_{i} ) \cdot {E}_{i} \vert . \qquad ( 1 )$$

Specifically, a difference in pixel values between a defective pixel and a pixel corresponding to the defective pixel is weighted using the pixel value of the defective pixel.

In the equation (1), Eᵢ is the pixel value of a defective pixel forming the defective image A in the defect reference image G3, and Fᵢ is the pixel value of a pixel forming an image of a corresponding area of the defect extraction image G13, the area positionally corresponding to the defective image A. Further, n is the number of pixels in the defective image A.

Next, other simple methods for identifying a defective area will be described. These identification methods have a characteristic that the accuracy is low but the processing speed is high. These methods are appropriate for identifying a relatively large defect. Here, for the purpose of simplifying description, a case in which the direction of shift in position of the defective area is Y direction, in other words, a case in which the direction of shift in position of the defective area is concentrated in a linear direction is assumed. However, in any of the methods, the direction of shift in position may be XY directions, in other words, two dimensional directions.

### 2) Identification Method by Evaluating Degree of Coincidence of Peak Positions in Density profiles of Defects

In this identification method, a peak position in the density (pixel value) profile of a defective image A in the defect reference image G3 and a peak position in the density profile of a corresponding-area image A′ in the subject image G11, the corresponding-area image A′ positionally corresponding to the defective image A, are compared with each other. Then, a position at which the degree of coincidence is the highest is identified as the position of the defective area B.

First, the density profile of the defective image A in the defect reference image G3 is obtained for each pixel column of the defective image A.

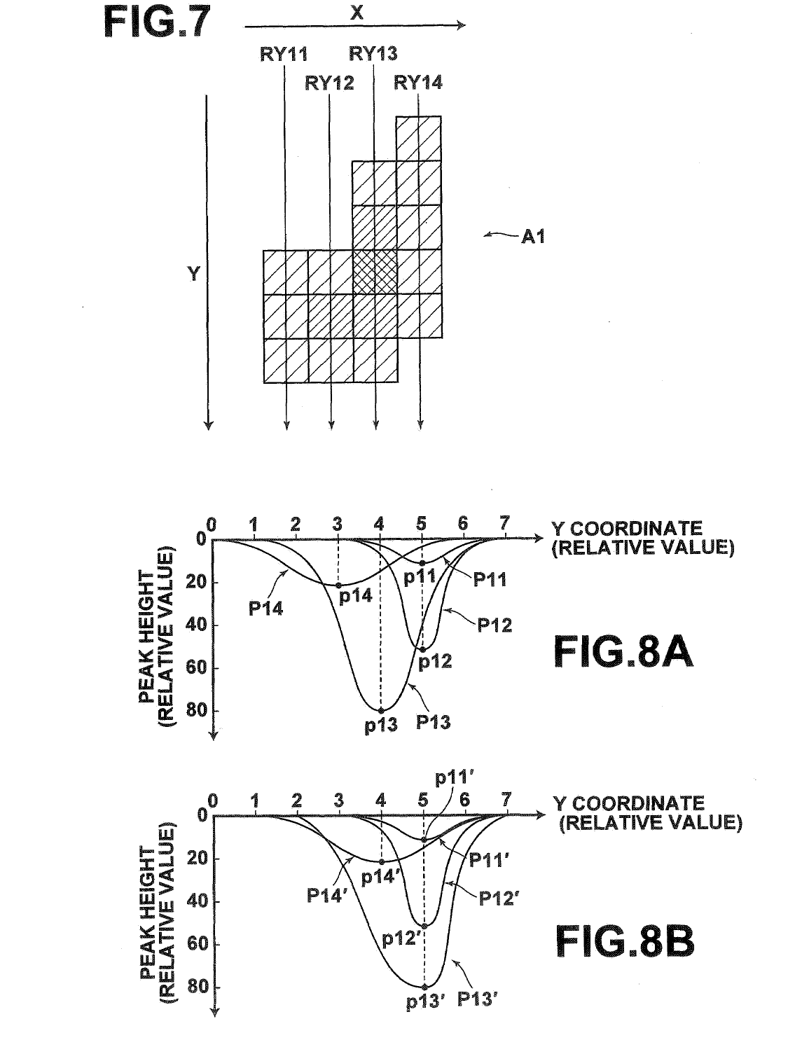

FIG. 7 is a diagram illustrating a defective image A1 in the defect reference image G3. FIG. 8A is a diagram illustrating the density profile of the defective image A1. In FIG. 8A, each of the density profiles P11 through P14 shows density fluctuation when the inside of the defective image A1 is observed along each of pixel columns RY11 through RY14, extending in the Y direction. In FIG. 8A, points p11 through p14 are peaks in the density profiles P11 through P14, respectively. In these density profiles, the horizontal axis represents the Y coordinates of pixels and the vertical axis represents pixel values.

Next, the density profile of the corresponding-area image A′ in the subject image G11 is obtained for each pixel column of the corresponding-area image A′.

FIG. 8B is a diagram illustrating the density profile of the corresponding-area image A1′ in the subject image G11. In FIG. 8B, each of the density profiles P11′ through P14′ shows density fluctuation when the inside of the corresponding-area image A1′ is observed along each of pixel columns RY11′ through RY14′, which positionally correspond to the pixel columns RY11 through RY14, respectively. In FIG. 8B, points p11′ through p14′ are peaks in the density profiles P11′ through P14′, respectively.

Here, the positions of the peaks in the density profiles of the defective image A and the positions of the peaks in the density profiles of the corresponding-area image A′, the peaks corresponding to each other, are compared with each other. Then, for each pair of corresponding peaks, a peak height ph in the defect reference image G3 and a shift amount psy of the peak position in the subject image G11 in the Y direction are obtained. The shift amount psy is a shift amount when the peak position in the defect reference image G3 is used as a standard. Further, peak heights ph of peaks having the same shift amount psy are accumulated for each shift amount psy, and a shift amount psy of which the accumulated amount is the highest is regarded as a position shift amount ΔY in the Y direction between the defective image A and the defective area B in the subject image G11, the defective area B corresponding to the defective image A. The correspondence between the peaks may be judged based on whether the peak heights are similar to each other. Alternatively, the correspondence may be judged based on whether pixel columns to which the peaks belong are identical with each other.

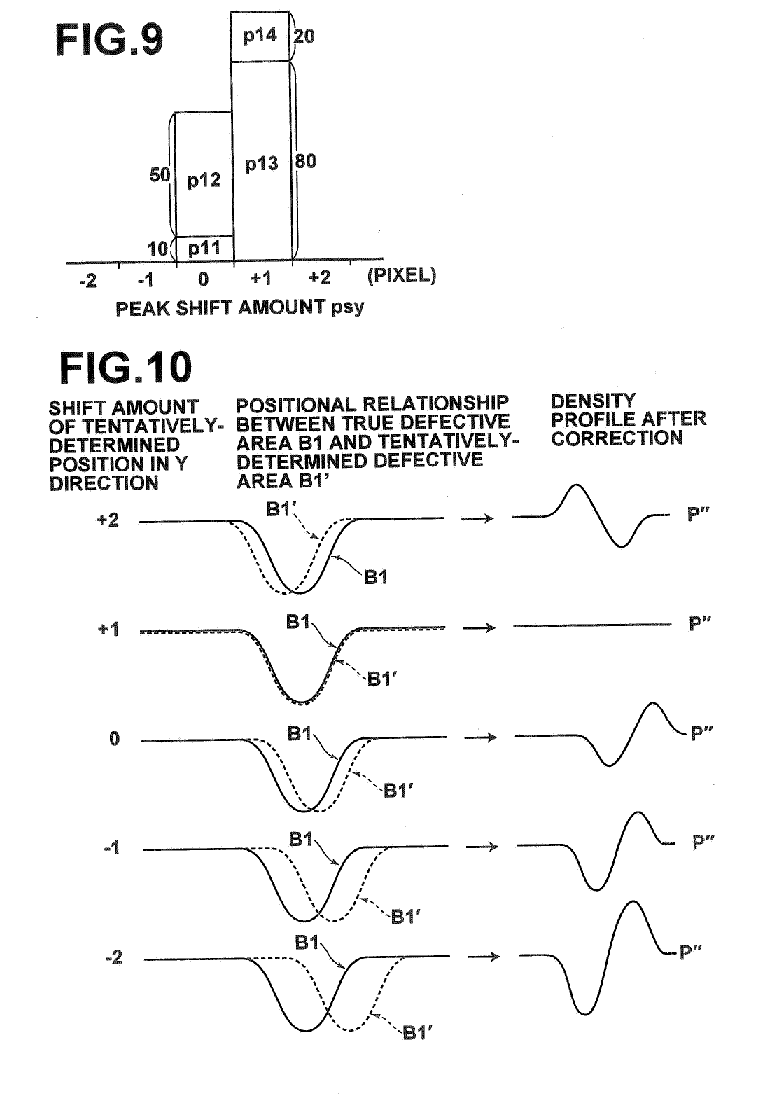

FIG. 9 is a diagram illustrating a correspondence between the shift amount psy in the Y direction and the accumulated amount of the peak heights ph. The shift amount psy is a shift amount between the defective image A1 and the corresponding area B1. In this example, a shift amount psy in the Y direction when the accumulated amount of the peak heights ph becomes the highest is “one pixel in +Y direction”. Therefore, a position shift amount ΔY in the Y direction in the defective area B1 of the subject image G11, the defective area B1 corresponding to the defective image A1, is “one pixel in +Y direction”.

Then, a position moved by the shift amount ΔY from the same position as the defective image A is identified as the position of the defective area B corresponding to the defective image A.

### 3) Identification Method by Evaluating Corrected Image at Each Position in the Vicinity of Defect

In this identification method, a range in which a defective area B is present in the subject image G11 is estimated based on the coordinates of the defective image A in the defect reference image G3. Then, defective areas are tentatively determined within the range and actual correction processing is sequentially performed on each of the tentatively-determined defective areas. Further, the correction results are evaluated and a tentatively determined position when the most appropriate correction result was obtained is identified as the position of a true defective area B. Then, the correction result of the true defective area B is adopted.

First, in the subject image G11, defective areas corresponding to the defective image A are tentatively determined. The defective areas are tentatively determined by shifting the positions of the tentatively determined areas in the Y direction within a predetermined range with the center of the range at the same coordinate as that of the defective image A in the defect reference image G3. Then, predetermined correction processing is performed on each of the tentatively-determined defective areas every time when the defective areas are tentatively determined. Accordingly, a plurality of corrected images G11′ are obtained.

FIG. 10 is a diagram illustrating positional relationships between a true defective area B1 and tentatively-determined defective areas B1′ and density profiles P″. The tentatively-determined defective areas B1′ are tentatively determined while the position of the defective area B1 is shifted within a range of ±2 pixels from the same coordinate position as that of the defective image A1. The density profile P″ is the density profile of a predetermined pixel column in Y direction in a defective area portion of each of the corrected images G11′, obtained every time when a defective area B1′ is tentatively determined. It is estimated that if an overlapped portion between the true defective area B1 and the tentatively-determined defective area B1′ is larger, an area that is appropriately corrected increases and that the peak and trough (up and down) of the density profile P″ of the defective area portion of the corrected image G11′ becomes small.

Next, to evaluate the height of the peak and trough, the sum of the absolute values of differences between two adjacent pixels is obtained for each pixel value Di in the density profile P″ as an evaluation value H, using the following equation(2):

$$H = {\sum }_{i = 1}^{n} \vert {D}_{i} - {D}_{i - 1} \vert . \qquad ( 2 )$$

Then, a tentatively-determined defective area B1′, of which the evaluation value H is the smallest, is regarded as the true defective area B1. Further, the correction result when the evaluation value H is the smallest is adopted as an appropriate correction result.

In the example illustrated in FIG. 10, the evaluation value H becomes the smallest when the position of the tentatively-determined defective area B1′ is shifted by +1 pixel in the Y-direction from the same coordinate position as that of the defective image A1. Therefore, the tentatively-determined defective area B1′ when the position of the tentatively-determined defective area B1′ is shifted by +1 pixel in the Y-direction from the same coordinate position as that of the defective image A1 is adopted as a correction result obtained when the correction has been appropriately performed.

### 4) Identification Method by Evaluating Degree of Coincidence of Direction of Density Gradient within Defect

In this identification method, distribution V of density gradients of a defective image A in the defect reference image G3 and distribution V′ of density gradients of an image in the vicinity of a corresponding area of the subject image G11, the corresponding area positionally corresponding to the defective image A, are compared with each other. Then, an area in which the degree of coincidence of the distribution V and the distribution V′ is the highest is identified as the defective area B.

First, the direction of the density gradient of each pixel in the defective image A in the defect reference image G3 is obtained.

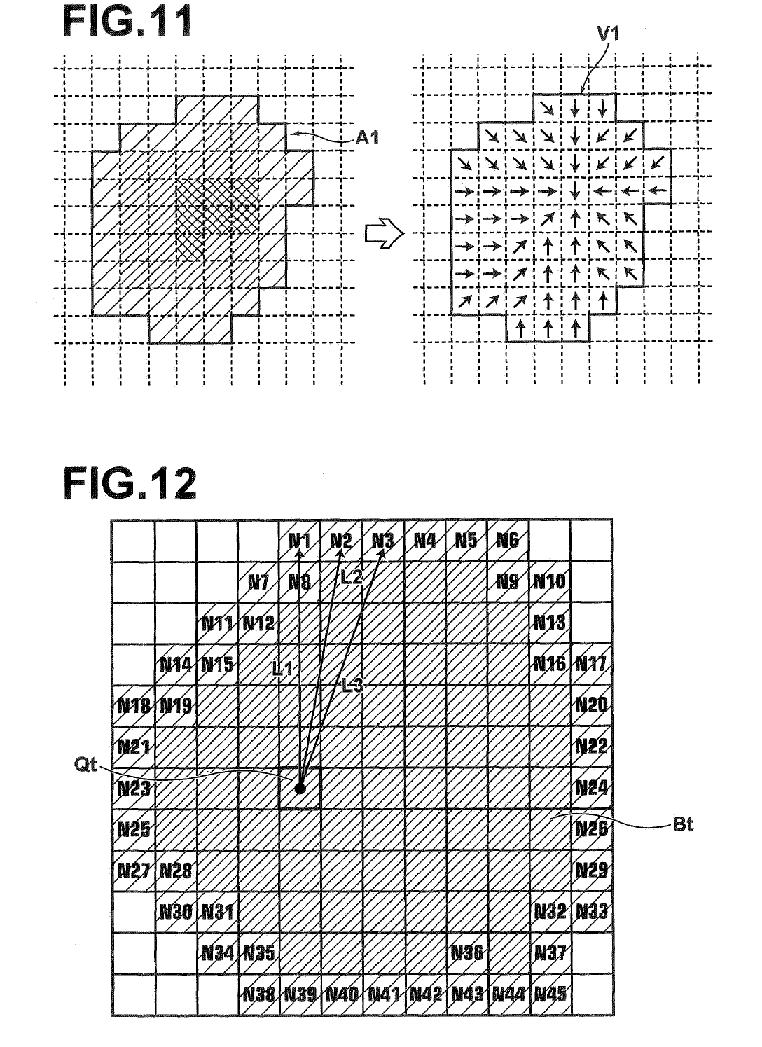

FIG. 11 is a diagram illustrating an example of distribution V1 of the directions of density gradients of the defective image A1 in the defect reference image G3. In FIG. 11, the direction of the density gradient of a pixel of interest in the defective image A1 of the defect reference image G3 is classified into eight directions of up, down, left, right and diagonal directions. The direction is classified into the eight directions by obtaining a direction in which the difference becomes the largest using the pixel values of 3×3 pixels with the pixel of interest at the center of the 3×3 pixels.

Next, in the subject image G11, defective areas corresponding to the defective image A are tentatively determined. The tentatively-determined defective areas are shifted in the Y direction within a predetermined range with the center at the position of the subject image G11 having the same coordinate as that of the defective image A in the defect reference image G3. Then, distribution V′ of density gradients is obtained in a similar manner for the tentatively-determined defective image B′ every time when the tentatively-determined defective image B′ is determined.

Then, the distribution V of the density gradients of the defective image A and the distribution V′ of the density gradients of the tentatively-determined defective area B′ are compared with each other, and defective pixel values of corresponding pixels in the distribution V of the density gradients of the defective image A are calculated. Then, points that are weighted more as the values of the defective pixel values are larger are generated, and the sum of the points is calculated as an evaluation value. This processing is performed on each of the tentatively-determined defective areas B′, and a tentatively-determined defective area B′ that has the highest evaluation value is identified as the true defective area B.

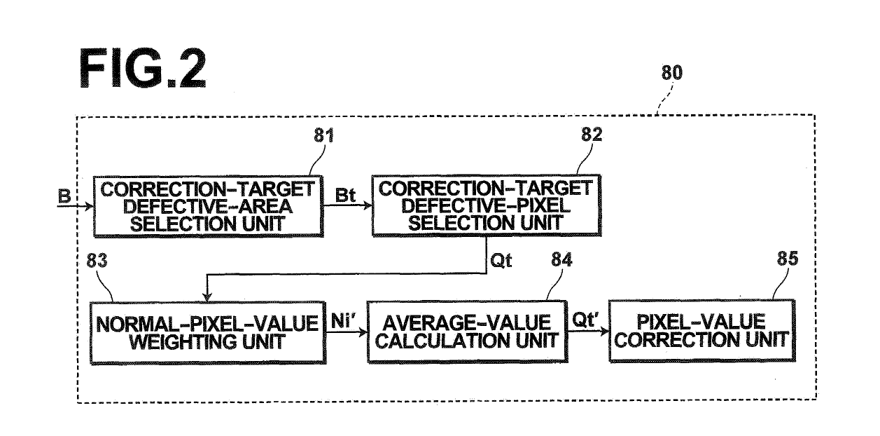

The correction processing unit 80 performs estimation-correction processing on the identified defective area B in the subject image G11 to correct the pixel values of the defective pixels. As illustrated in FIG. 2, the correction processing unit 80 includes a correction-target defective-area selection unit 81, a correction-target defective-pixel selection unit 82, a normal-pixel-value weighting unit 83, an average-value calculation unit 84 and a pixel value correction unit 85.

FIG. 12 is a diagram illustrating a defective area B1 in the subject image G11 and a plurality of normal pixels N1, N2, . . . adjacent to the periphery of the defective area B1.

The correction-target defective-area selection unit 81 selects one of the identified defective areas B1, B2, . . . in the subject image G11 as a correction target defective area Bt.

The correction-target defective-pixel selection unit 82 selects one of a plurality of defective pixels forming the correction-target defective-area Bt selected by the correction-target defective-area selection unit 81 as a correction-target defective pixel Qt.

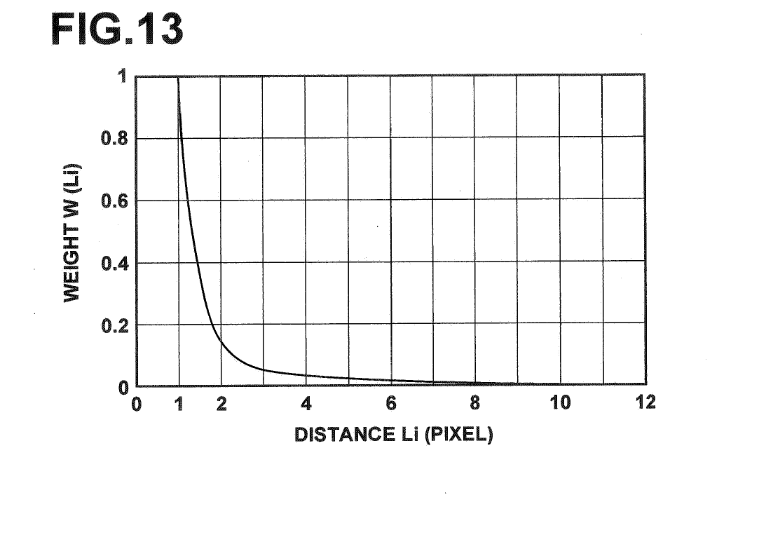

The normal-pixel-value weighting unit 83 weights the pixel value Ni of the normal pixel Ni (hereinafter, the same sign is used to represent a normal pixel and the pixel value of the normal pixel) for each pair of the correction-target defective pixel Qt and each of normal pixels Ni (i=1, 2, . . . ) adjacent to the periphery of the correction-target defective area Bt. Weighting is performed in such a manner that the pixel value Ni is weighted less as a distance Li between the correction-target defective pixel Qt and the normal pixel Ni becomes longer. Accordingly, a plurality of weighted normal pixel values Ni′ are obtained. Here, the normal-pixel-value weighting unit 83 obtains the weighted normal pixel value Ni′ by multiplying the pixel value Ni of the normal pixel Ni by a weighting coefficient W(Li) corresponding to the distance Li. Appropriate correction data can be obtained by changing the degree of dependence of the weighting coefficient W(Li) to the distance Li, and it is necessary that an appropriate weighting coefficient W(Li) is determined based on the performance of a detector, particularly the sharpness of the detector. As an example of the weighting coefficient W(Li), a function satisfying W(Li)→0 as Li→∞(∞ is infinity) should be used. The function may be an exponentially decreasing function. FIG. 13 is a diagram illustrating an example of the weighting coefficient W(Li). This curve is generated using a function that is 2⁻³ when the distance Li is within the range of 1 to 2 pixels and 2⁻³ when the distance Li exceeds 2 pixels.

The average-value calculation unit 84 calculates an average value Qt′ of the plurality of weighted normal pixel values Ni′, obtained as described above.

The pixel value correction unit 85 corrects the pixel value Qt of the correction-target defective pixel Qt by replacing the pixel value Qt with the calculated average value Qt′.

An equation for calculating the average value Qt′ is, for example, the following equation (3):

$${Q}_{t}^{′} = \frac{{\sum }_{i = 1}^{n} [ W ( {L}_{i} ) \times {N}_{i} ]}{{\sum }_{i = 1}^{n} W ( {L}_{i} )} . \qquad ( 3 )$$

Next, the flow of processing at the defective-area correction apparatus 200 according to the present embodiment will be described.

First, the image obtainment unit 50 generates a uniformly exposed image Sz by averaging a plurality of images obtained by the radiographic system 100 by performing a plurality of times of uniform exposure photography at high dose, or the like. Further, the image obtainment unit 50 receives a subject image Sb obtained by the radiographic system 100 by performing radiography on a subject Ml.

Next, the defect-reference-image obtainment unit 60 extracts, as defective images A1, A2, . . . , an area in which at least a predetermined number of pixels having pixel values (density values) that are less than or equal to a predetermined threshold value are substantially consecutively present in a predetermined manner from the uniformly exposed image G1. Then, the defect-reference-image obtainment unit 60 generates a defect reference image G3 including only the defective images A1, A2, . . . , extracted from the uniformly exposed image G1. At this time, the threshold value for judging the defect is changed according to the adopted method for identifying defective areas, and the sizes of the defective images A1, A2, . . . to be extracted are adjusted. Further, a pseudo-defect generated by adhesion of dust to a panel on the storage phosphor sheet 1 and a defect that is not easily recognizable, which does not require correction, are eliminated from the defects to be extracted.

When the defect reference image G3 is obtained, the defective area identification unit 70 uses one of the aforementioned defective area identification methods and identifies defective areas B1, B2, . . . in the subject image G11 with reference to the defect reference image G3.

When the defective areas B1, B2, . . . are identified in the subject image G11, the correction processing unit 80 performs processing on the defective areas B1, B2, . . . to correct the pixel values of the defective pixels in the defective areas B1, B2, . . . . Specifically, the correction-target defective-area selection unit 81 selects one of the identified defective areas B1, B2, . . . in the subject image G11 as the correction-target defective area Bt. Further, the correction-target defective-pixel selection unit 82 selects one of a plurality of defective pixels forming the correction-target defective area Bt as a correction-target defective pixel Qt. Further, the normal-pixel-value weighting unit 83 weights the pixel value Ni of the normal pixel Ni for each pair of the correction-target defective pixel Qt and each of normal pixels Ni adjacent to the periphery of the correction-target defective area Bt. Weighting is performed in such a manner that the pixel value Ni is weighted less as a distance Li between the correction-target defective pixel Qt and the normal pixel Ni becomes longer. Accordingly, a plurality of weighted normal pixel values Ni′ are obtained. The average-value calculation unit 84 calculates an average value Qt′ of the plurality of weighted normal pixel value Ni′, obtained as described above. The pixel value correction unit 85 replaces the pixel value Qt of the correction-target defective pixel Qt with the calculated average value Qt′.

When processing on the correction-target defective pixel Qt ends, the correction-target defective-pixel selection unit 82 selects a new defective pixel as a correction-target pixel, and a similar correction processing is performed on the pixel. This processing is repeated until all of defective pixels in the correction-target defective area Bt are corrected, in other words, until no uncorrected defective pixel is present in the correction-target defective area Bt.

When processing on the correction-target defective area Bt ends, the correction-target defective area selection unit 81 selects a new defective area as a correction target and similar correction processing is performed. This processing is repeated until all of the defective areas are corrected, in other words, until no uncorrected defective area is present.

As described above, in the present embodiment, a plurality of weighted normal pixel value Ni′ are obtained by weighting the pixel values Ni of the normal pixels Ni using a weighting coefficient [W(Li)×n/ΣW(Li)] for each pair of the correction-target defective pixel Qt and each of normal pixels Ni adjacent to the periphery of the correction-target defective area Bt. The weighting coefficient is a coefficient that weights the pixel value Ni less as a distance Li between the correction-target defective pixel Qt and the normal pixel Ni becomes longer. Then, an average value Qt′ of the plurality of weighted normal pixel values Ni′ is obtained. Further, the pixel value of the correction-target defective pixel Qt is replaced with the calculated average value Qt′. Therefore, when correction processing is performed on the defective area B including a plurality of defective pixels, defective pixels located close to the normal pixels on the outside of the defective area are corrected in such a manner that the pixel values of normal pixels in the vicinity of the defective pixels are highly reflected in the corrected values. In contrast, defective pixels located close to the center of the defective area are corrected in such a manner that the pixel values become close to an average value of the pixel values of normal pixels on the periphery of the defective area B. Accordingly, the defective area B is corrected so that the corrected defective area has more natural density (tone).

In the aforementioned embodiments of the present invention, an example using a CR method, in which image data is obtained by detecting stimulated-emission light emitted from the storage phosphor sheet by a line sensor or the like, was described. Further, the present invention may be applied, for example, to a digital radiography (DR) method, in which image data is obtained by using a photo-electric conversion element, such as a two-dimensionally arranged TFT's (thin film transistors).

In the CR method, the defective area of the image changes in each obtainment of image data. Therefore, it is necessary to identify a defective area every time when image data is obtained. In contrast, in the DR method, the defective area of the image does not change. Therefore, if once a defective area is identified in the image, it is possible to omit the process for identifying the defective area.

What is claimed is:

1. A defective-area correction apparatus for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the apparatus comprising:
a normal-pixel-value weighting means for obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;
an average-value calculation means for calculating an average value of the obtained plurality of weighted normal pixel values; and
a pixel value correction means for correcting the pixel value of the correction target defective pixel using the calculated average value.

2. A defective-area correction apparatus, as defined in claim 1, wherein the pixel value correction means replaces the pixel value of the correction target defective pixel with the calculated average value.

3. A defective-area correction apparatus, as defined in claim 1, wherein the normal-pixel-value weighting means obtains the weighted normal pixel values by multiplying the pixel value of each of the normal pixels by a weighting coefficient, the weighting coefficient becoming exponentially smaller depending on the distance.

4. A defective-area correction apparatus, as defined in claim 2, wherein the normal-pixel-value weighting means obtains the weighted normal pixel values by multiplying the pixel value of each of the normal pixels by a weighting coefficient, the weighting coefficient becoming exponentially smaller depending on the distance.

5. A defective-area correction method for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the method comprising:
obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;
calculating an average value of the obtained plurality of weighted normal pixel values; and
correcting the pixel value of the correction target defective pixel using the calculated average value.

6. A computer-readable recording medium having stored therein a program for causing a computer to function as a defective-area correction apparatus for correcting the pixel values of a plurality of defective pixels forming a defective area of an image representing a subject image, the defective area corresponding to a defective portion of a detector, by obtaining the image representing the subject image by detection of one of light and radiation including information about the subject image by use of the detector and by identifying the defective area of the image representing the subject image, the program comprising the procedures for causing the computer to function as:
a normal-pixel-value weighting means for obtaining a plurality of weighted normal pixel values by weighting the pixel value of each of normal pixels adjacent to the periphery of the defective area for each pair of a defective pixel, the defective pixel being a correction target defective pixel, and each of the normal pixels using a weighting coefficient, the weighting coefficient becoming smaller as a distance between the correction target defective pixel and the normal pixel becomes longer;
an average-value calculation means for calculating an average value of the obtained plurality of weighted normal pixel values; and
a pixel value correction means for correcting the pixel value of the correction target defective pixel using the calculated average value.

7. A radiation detection apparatus comprising:
a radiation detection means for storing a latent image of a subject;
an image generation means for generating image data by reading the latent image from the radiation detection means;
a defective-area identification means for identifying a defective area of an image represented by the generated image data, the defective area including a set of at least two defective pixels;
a defective-pixel identification means for identifying a first defective pixel within the defective area;
a normal-pixel identification means for identifying a first normal pixel adjacent to the periphery of the defective area;
a distance measurement means for measuring a first distance between the first defective pixel and the first normal pixel;
a weighting-coefficient calculation means for calculating a weighting coefficient, the weighting coefficient becoming smaller as the distance measured by the distance measurement means becomes longer;
a normal-pixel-data-value weighting means for obtaining a first weighted normal pixel data value by multiplying the data value of the first normal pixel by a weighting coefficient corresponding to the distance; and
a defective-pixel data value correction means for replacing the data value of the first defective pixel with an average value of a plurality of weighted normal pixel data values including the first weighted normal pixel data value and a second weighted normal pixel data value, the second weighted normal pixel data value being obtained with respect to a second normal pixel, the second normal pixel being different from the first normal value identified by the normal pixel identification means, by calculating the average value.

8. A radiation detection apparatus comprising:
a radiation detection unit for storing a latent image of a subject;
an image generation unit for generating image data by reading the latent image from the radiation detection unit;
a defective-area identification unit for identifying a defective area of an image represented by the generated image data, the defective area including a set of at least two defective pixels;
a defective-pixel identification unit for identifying a first defective pixel within the defective area;
a normal-pixel identification unit for identifying a first normal pixel adjacent to the periphery of the defective area;
a distance measurement unit for measuring a first distance between the first defective pixel and the first normal pixel;
a weighting-coefficient calculation unit for calculating a weighting coefficient, the weighting coefficient becoming smaller as the distance measured by the distance measurement unit becomes longer;
a normal-pixel-data-value weighting unit for obtaining a first weighted normal pixel data value by multiplying the data value of the first normal pixel by a weighting coefficient corresponding to the distance; and
a defective-pixel data value correction unit for replacing the data value of the first defective pixel with an average value of a plurality of weighted normal pixel data values including the first weighted normal pixel data value and a second weighted normal pixel data value, the second weighted normal pixel data value being obtained with respect to a second normal pixel, the second normal pixel being different from the first normal value identified by the normal pixel identification unit, by calculating the average value.
